(19) United States
(12) Patent Application Publication
(10) Pub. No.: US 2003/0094299 A1
(43) Pub. Date: May 22, 2003

(54) Anti-disturbing device for terminals

(76) Inventor: Hsiao Lung Lee, Chong Ho City (TW)

Correspondence Address: Hsiao Lung Lee, P.O. Box 10-69, Chong Ho, 235, TW

(21) Appl. No.: 09/988,432

(22) Filed: Nov. 20, 2001

(51) Int. Cl. H02G 3/18

(52) U.S. Cl. 174/59

(57) ABSTRACT

An electric facility includes a board having a number of openings formed in the peripheral portion and a number of conductors applied around the openings. A number of casings are engaged in the openings of the board and electrically coupled to the conductors of the board. A number of terminals each has one end engaged into the casing for being grounded to the board by the casing and the conductors. The casing includes two side panels and one or more end panels for engaging with the terminal. The side panels each has a flap for engaging with and for retaining the terminal in the casing.

### BACKGROUND OF THE INVENTION

1. Field of the Invention

The present invention relates to an anti-disturbing device, and more particularly to an anti-disturbing device for terminals of electric facilities.

2. Description of the Prior Art

Typical electric facilities comprise a number of terminals coupled to various kinds of electric elements, such as the transformers, the capacitors, the inductors, the transistors, and the like which may include or may generate various kinds of frequencies, such that the frequencies of the electric elements and/or the terminals may be disturbed or affected with each other.

The present invention has arisen to mitigate and/or obviate the afore-described disadvantages of the conventional terminals for the electric facilities.

### SUMMARY OF THE INVENTION

The primary objective of the present invention is to provide an anti-disturbing device for shielding the terminals and for preventing the terminals from being disturbed or affected by the other electric elements, and for preventing the terminals from disturbing or affecting the other electric elements.

In accordance with one aspect of the invention, there is provided an electric facility comprising a board including at least one opening formed therein, and including a conductor provided around the opening thereof, a casing including a chamber formed therein and including two side panels engaged in the opening of the board and electrically coupled to the conductor of the board, at least one terminal including a first end engaged into the chamber of the casing and engaged with the side panels of the casing, and means for securing the first end of the terminal in the chamber of the casing. The first end of the terminal may thus be shielded and covered and engaged within the casing and may be electrically coupled to the board and may thus be grounded to the board. The shielded first end of the terminal may thus be prevented from being disturbed or affected by the other electric elements, and may be prevented from disturbing or affecting the other electric elements.

The securing means includes at least one end panel extended from the casing and engaged with the first end of the terminal for retaining the first end of the terminal in the chamber of the casing.

The end panel includes at least one extension extended therefrom for securing to the board. The end panel is bent and folded from a first of the side panels.

The securing means includes a flap extended from the side panel and engaged with the first end of the terminal for retaining the first end of the terminal in the chamber of the casing.

The side panels each includes a flange laterally extended outward therefrom and engaged with the conductor of the board.

The side panels each includes at least one extension extended therefrom for securing to the board.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is an upper perspective view of an electric facility having an anti-disturbing device for terminals in accordance with the present invention;

FIG. 2 is a bottom perspective view of the electric facility;

FIG. 3 is an upper perspective view of a board and a terminal secured together with the anti-disturbing device;

FIG. 4 is a bottom plan view of the board and the terminal and the anti-disturbing device;

FIG. 5 is an exploded view of the board and the terminal and the anti-disturbing device;

FIG. 6 is a perspective view of the terminal and the anti-disturbing device; and

FIG. 7 is an exploded view of the terminal and the anti-disturbing device.

### DETAILED DESCRIPTION OF THE PREFERRED EMBODIMENT

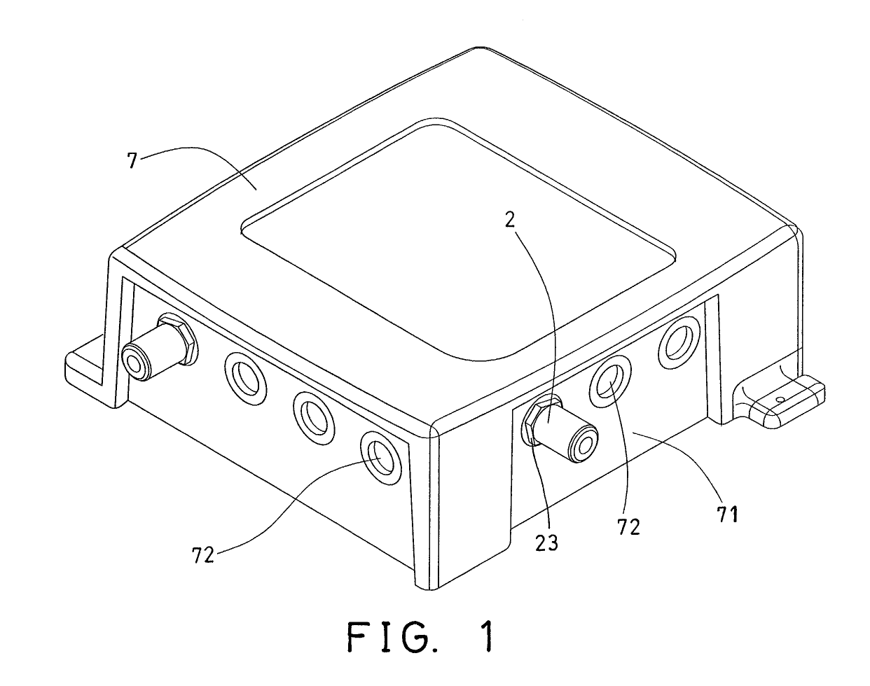

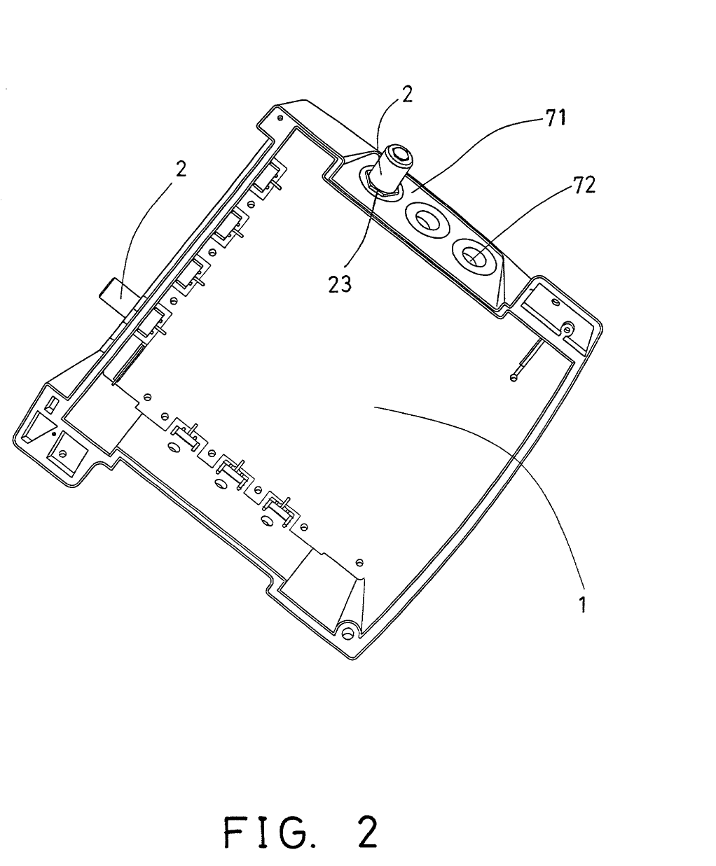

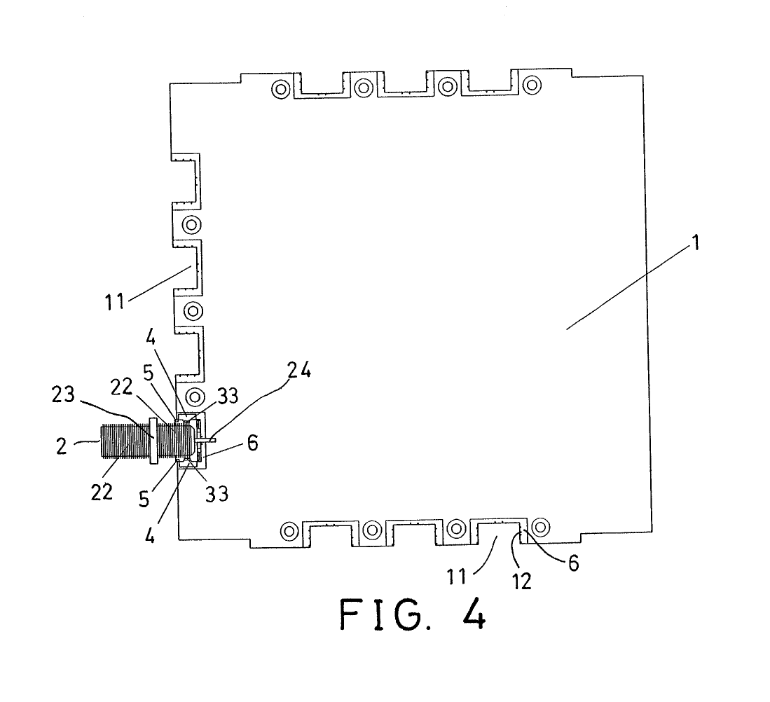

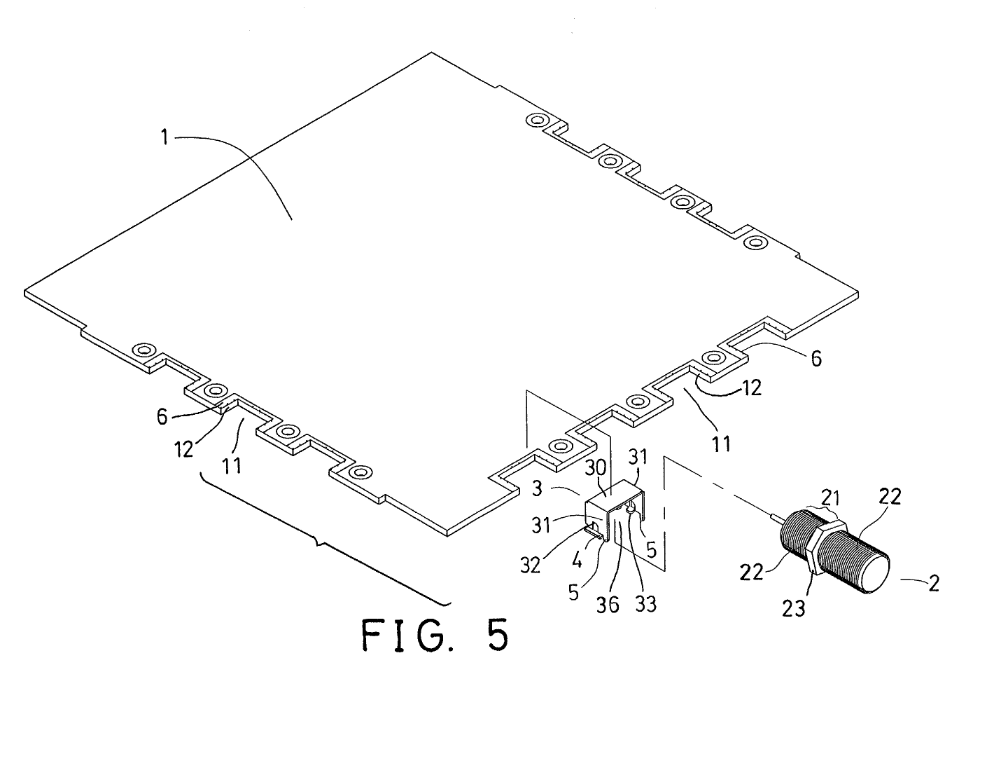

Referring to the drawings, and initially to FIGS. 1-5, an electric facility in accordance with the present invention comprises a housing 7 including one or more walls or side walls 71 each having one or more screw holes 72 formed therein for threading with one or more terminals 2 therein respectively. The terminals 2 each includes an outer thread 22 formed thereon for threading with the screw holes 72 of the housing 7, and each includes one end portion 21 engaged into the housing 7. A lock nut 23 may be threaded onto the terminals 2 and threaded with the outer thread 22 of the terminals 2 and engaged with the housing 7 for securing the terminals 2 to the housing 7. The terminals 2 each includes a core 24 extended therefrom for electrically coupling to various kinds of electric elements, such as the transformers, the capacitors, the inductors, the transistors, that may be disposed on the board 1.

An electric board or a base board 1 is to be secured in the housing 7 with such as fasteners, latches, or adhesive materials, or by welding processes. The board 1 includes an outer peripheral portion having a number of openings 11 formed therein, and formed or defined by a U-shaped peripheral fence 12, and includes a number of conductors 6 applied around the openings 11, or applied on the peripheral fences 12, such as applied onto the upper and/or the bottom surfaces of the peripheral fences 12 of the board 1.

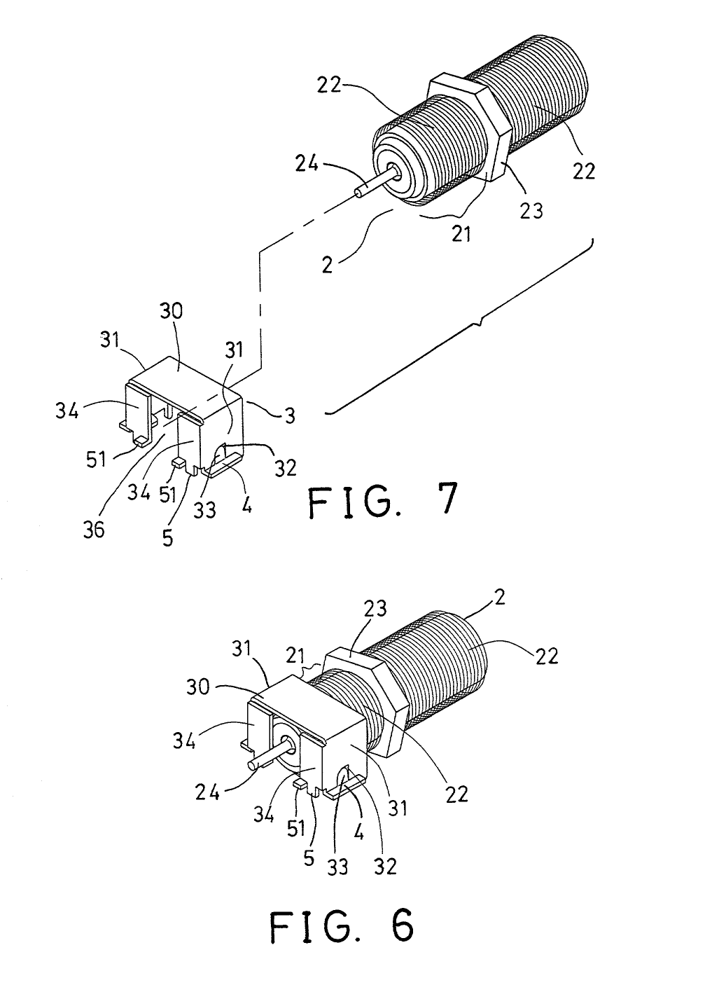

An anti-disturbing device 3 is provided for electrically coupling the terminals 2 to the board 1, or for grounding the terminals 2, and may be a casing 3 including an upper panel 30 and two side panels 31 extended downward from the sides of the upper panel 30, and two end panels 34 provided on the front or the rear portion of the casing 3, for forming a chamber 36 within the casing 3 and for receiving the end portion 21 of the terminal 2. The end panels 34 are preferably bent or folded from the side panels 31, best shown in FIGS. 6 and 7. The side panels 31 each includes an orifice 32 formed therein, and a flap 33 formed or punched inward of the housing 3 from the side panels 31, such that the orifices 32 may be formed in the flaps 33 respectively after the flaps 33 have been punched inward of the casing 3 from the side panels 31. The flaps 33 may be engaged with the bottom portion of the terminal 2 for stably retaining the terminal 2 in the casing 3.

The side panels 31 and the end panels 34 of the casing 3 may be engaged with the peripheral fences 12 of the board 1 and may be secured to the board 1 with such as a force-fitted engagement. The side panels 31 each includes a flange 4 extended laterally outward from the bottom portion thereof and engaged with the conductors 6 of the board 1. The casing 3 is made of conductive materials for electrically coupling the terminals 2 to the board 1, or for grounding the terminals 2 to the board 1. The side panels 31 and/or the end panels 34 may each further include one or more extensions 5, 51 for engaging with the conductors 6 and for further solidly and electrically coupling the terminals 2 to the board 1, and/or for allowing the casing 3 to be easily welded to the conductors 6 of the board 1.

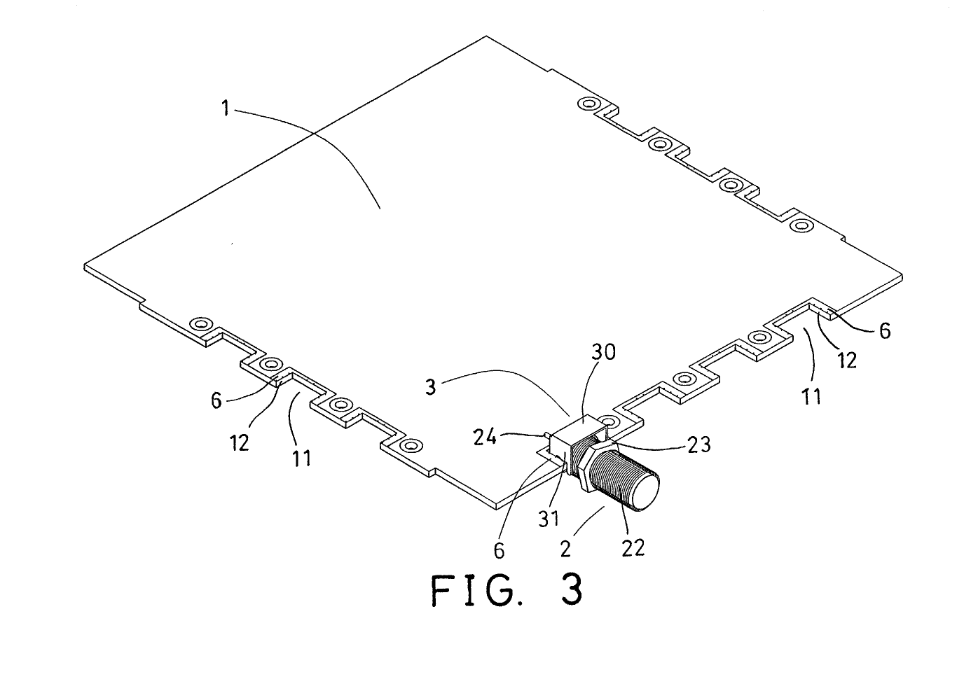

In operation, as shown in FIG. 3, the end portion 21 of the terminal 2 may be shielded and covered and engaged within the casing 3 and may be electrically coupled to the board 1 and may thus be grounded to the board 1. The shielded end portion 21 of the terminal 2 may thus be prevented from being disturbed or affected by the other electric elements, and may be prevented from disturbing or affecting the other electric elements. The end portion 21 of the terminal 2 may be stably secured or retained in the chamber 36 of the casing 3 by the upper panel 30, and the side panels 31, and the end panels 34, and the flaps 33 of the side panels 31, and may be solidly locked to the housing 7 with the lock nut 23.

Accordingly, the electric facility in accordance with the present invention may be provided for shielding the terminals and for preventing the terminals from being disturbed or affected by the other electric elements, and for preventing the terminals from disturbing or affecting the other electric elements.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An electric facility comprising:
a board including at least one opening formed therein, and including a conductor provided around said at least one opening thereof,
a casing including a chamber formed therein and including two side panels engaged in said at least one opening of said board and electrically coupled to said conductor of said board,
at least one terminal including a first end engaged into said chamber of said casing and engaged with said side panels of said casing, and
means for securing said first end of said at least one terminal in said chamber of said casing.

2. The anti-disturbing device according to claim 1, wherein said securing means includes at least one end panel extended from said casing and engaged with said first end of said at least one terminal for retaining said first end of said at least one terminal in said chamber of said casing.

3. The anti-disturbing device according to claim 2, wherein said at least one end panel includes at least one extension extended therefrom for securing to said board.

4. The anti-disturbing device according to claim 2, wherein said at least one end panel is bent and folded from a first of said side panels.

5. The anti-disturbing device according to claim 1, wherein said securing means includes a flap extended from said side panel and engaged with said first end of said at least one terminal for retaining said first end of said at least one terminal in said chamber of said casing.

6. The anti-disturbing device according to claim 1, wherein said side panels each includes a flange laterally extended outward therefrom and engaged with said conductor of said board.

7. The anti-disturbing device according to claim 1, wherein said side panels each includes at least one extension extended therefrom for securing to said board.
